(19) United States
(12) Patent Application Publication
(10) Pub. No.: US 2025/0351814 A1
(43) Pub. Date: Nov. 20, 2025

(54) CRITTER STOPS

(71) Applicant: Edward J. Paquette, Ventura, CA (US)

(72) Inventor: Edward J. Paquette, Ventura, CA (US)

(21) Appl. No.: 18/793,591

(22) Filed: Aug. 2, 2024

Related U.S. Application Data
(60) Provisional application No. 63/649,883, filed on May 20, 2024.

(51) Int. Cl. A01M 29/30

(52) U.S. Cl. CPC A01M 29/30

(57) ABSTRACT

There is disclosed a pest deterrent device designed for installation behind garage door seals to prevent the entry of pests through gaps between the garage door and door jambs. The device features a distinctive trapezoidal taper on the shorter anterior side, which faces the garage door upon installation. The device is engineered to fit seamlessly under the door jamb and door seal, providing an effective barrier against pests.

### RELATED APPLICATION INFORMATION

This patent claims priority from the following provisional patent application, titled “CRITTER STOPS,” application Ser. No. 63/649,883

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to home construction materials, door installers and door manufactures and pest control methods. Specifically, modifications and physical devices designed to reduce pest infestations through garage doors.

### Description of the Related Art

In the construction and maintenance of residential homes, one persistent challenge is the prevention of pests such as rats, insects, and snakes from entering living spaces. These pests often exploit gaps and openings in the structure, with doorways, particularly garage doors, being vulnerable points of entry. To address these issues, various methods and products have been developed, including weather stripping, door sweeps, wire mesh, caulk, threshold seals, automated door systems, ultrasonic pest repellents, and smart home integration solutions, which aim to block openings around the door edges and at the bottom where pests can enter.

Additionally, some methods involve replacing damaged garage doors and repairing holes in walls and flooring to eliminate access points for pets; however, these approaches tend to be drastic and costly. Despite these efforts, conventional solutions typically do not deter small pests, such as mice, which can find their way through even the smallest openings. Moreover, pests can chew or gnaw through these traditional mechanisms, rendering them ineffective. This ongoing challenge underscores the need for improved methods and devices that provide a more reliable and durable pest deterrent to prevent pest entry through doorways, particularly garage doors.

Many have attempted to deter pests by using durable materials such as concrete or steel in construction. This approach aims to create an impenetrable barrier. Additionally, sealing joints and seams in metal or vinyl panels is another method employed to prevent pests from chewing through these structures. Storing items off the floor in sealed cabinets reduces the attraction for pests that thrive on clutter and debris. Regular cleaning and organization also help by eliminating food waste and nesting materials. Despite these efforts, these methods often prove inadequate, particularly against small rodents, which can easily chew through most sealing materials.

Traditional pest control methods in garages, such as spraying insecticides and setting traps, offer only temporary relief by reducing visible pest activity. However, they fail to provide long-term solutions. Pests can survive and reproduce despite these measures, often returning in greater numbers. Furthermore, pests can develop resistance to chemicals after repeated exposure, diminishing the effectiveness of such treatments over time. Sealing entry points and repairing cracks in walls or foundations can address some issues, but pests are highly adaptable and can easily find or create new access points. They are motivated to infiltrate structures that offer shelter, food, and breeding grounds.

The common approaches to pest control in garages often fall short of solving the problem effectively. While these methods may temporarily reduce pest activity, they do not offer a permanent solution. The persistent nature of pests, particularly rodents, and their ability to adapt and overcome barriers highlight the need for a more effective approach.

Therefore, there is a clear need for a simple, robust, and cost-effective solution to prevent pests from entering garage areas. This disclosure presents an innovative solution designed to address the shortcomings of traditional methods, providing a more reliable and long-lasting defense against pest infestations.

### DESCRIPTION OF THE DRAWINGS

FIG. 1 is a front-facing street view of the garage door, illustrating the gaps between the garage door and door jambs that provide entry points for pests.

FIG. 2 illustrates the same front-facing street view of the garage door with the pest deterrent devices installed, demonstrating how they prevent pests from entering and force them to seek shelter elsewhere

FIG. 3 is an exploded view illustrating the individual components of the pest deterrent device.

FIG. 4 is a cross-sectional view from the street perspective, showing the right and left configurations of the pest deterrent device installed behind the garage door seal.

FIG. 5 is a magnified cross-sectional view from above, detailing the right-side installation of the pest deterrent device behind the garage door seal, with the left side implied by horizontal mirroring.

Throughout this description, elements appearing in figures are assigned three-digit reference designators, where the most significant digit is the figure number, and the two least significant digits are specific to the element. An element that is not described in conjunction with a figure may be presumed to have the same characteristics and function as a previously described element having a reference designator with the same least significant digits.

### DETAILED DESCRIPTION

Garage doors frequently serve as entry points for pests and rodents due to several inherent vulnerabilities. These vulnerabilities arise from various factors, including improper sealing, aging, and wear. Garage doors are not always tightly sealed, leaving small gaps that pests can exploit. Over time, garage doors can become old and worn, increasing their susceptibility to pest infiltration. Poor construction can result in gaps between the doors and door jambs, providing easy access for pests. Additionally, weather conditions such as extreme heat or cold can warp garage doors, creating new gaps and enlarging existing ones. The materials used in garage doors can also erode or weaken over time, diminishing their ability to keep pests out.

Pests and rodents can exploit these weaknesses to gain entry into garages and, subsequently, homes. Once inside, they can create nests and establish breeding grounds. Common pests that enter through garage doors include mice, rats, insects, snakes, and spiders. Garages provide an ideal environment for pests to nest and breed due to the clutter often found in them, which offers ample hiding spots and nesting materials. Rodents, in particular, are notorious for chewing through materials, damaging stored items, wiring, insulation, and even the structure of the garage itself. Additionally, pests can carry diseases and parasites, posing health risks to homeowners. Rodents, for example, are known carriers of Hantavirus and Salmonella. Once pests establish themselves in the garage, they can easily spread to other parts of the home, causing further damage and health risks.

In addition to rodents, a variety of other pests can exploit the vulnerabilities of garage doors to gain entry into homes. Insects such as ants, termites, and cockroaches are particularly adept at finding their way through even the smallest cracks and gaps. Ants can create extensive colonies and often seek out food sources, leading to infestations in kitchens and pantries. Termites are notorious for their ability to chew through wood, potentially causing significant structural damage to the garage and home. Cockroaches, on the other hand, can spread diseases and contaminate food sources, posing serious health risks.

Spiders are another common invader that can enter through poorly sealed garage doors. While many spiders are harmless, some species can be venomous, posing a risk to occupants. Additionally, spider webs and egg sacs can create an unsightly and unhygienic environment. Wasps and bees can also find their way into garages, particularly if there are small openings or damaged areas. These insects can build nests, leading to potential stings and allergic reactions for homeowners.

Once these pests gain entry, they can cause a range of problems. Insects like ants and cockroaches can contaminate food and surfaces with bacteria, increasing the risk of foodborne illnesses. Termites can compromise the structural integrity of a building by tunneling through wooden components. The presence of spiders and their webs can create an unclean appearance and may lead to bites if disturbed. Wasps and bees can pose a direct threat to safety with their stings, especially for individuals with allergies.

In addition to insects and spiders, reptiles such as snakes can also exploit the gaps and weaknesses in garage doors to gain entry into homes. Snakes are particularly skilled at squeezing through small openings, making poorly sealed garage doors an easy access point. Once inside, they can pose a significant threat to safety, especially if venomous. Even non-venomous snakes can cause fear and anxiety among homeowners, and their presence indicates a breach that other pests can exploit as well.

Rats, in particular, are highly harmful pests. They are notorious for their destructive chewing habits, which can lead to extensive damage. Rats can gnaw through a wide range of materials, including wood, plastic, and even electrical wiring, posing a fire hazard. Their adaptability allows them to thrive in various environments, making them difficult to eradicate once they establish themselves. Additionally, rats are aggressive and can contaminate food sources with their droppings and urine, spreading diseases such as Leptospirosis and Hantavirus.

Squirrels and other small mammals, such as raccoons and opossums, can also find their way into garages through improperly sealed doors. Squirrels, like rats, have strong teeth capable of chewing through many materials. They can cause significant damage by gnawing on insulation, electrical wires, and stored items. Raccoons and opossums, while larger, are equally adept at finding and creating entry points. These animals can overturn trash cans, create nests, and leave behind droppings that pose health risks.

Therefore, it is essential to construct a garage using durable materials to prevent infestations and ensure long-term structural integrity. Doors and door jambs should be constructed from high-quality materials such as treated wood, metal, or concrete. Walls constructed from concrete serve as an excellent shield since it is difficult for pests to penetrate and is highly durable, lasting over time. Additionally, the joints and seems of a garage door and the overall structure must be securely fastened with screws or concrete adhesive to prevent any gaps or weaknesses that pests could exploit. Proper sealing of these joints with weather stripping, caulk, or other sealing materials further enhances the barrier against infestations. By prioritizing the use of robust, pest-resistant construction materials and ensuring all connections are tightly secured, homeowners can maintain a clean, safe, and secure environment within their garages, effectively protecting their health, hygiene, stored belongings, and vehicles.

The entry of these various pests through unwanted openings in the space between garage doors and door jambs highlights the critical need for a robust solution to effectively prevent infestations and the associated damages.

In some instances, garage doors may be installed without any seals, leaving gaps around the edges. This lack of seals can result in several issues, such as drafts entering the garage, increased energy costs due to temperature fluctuations, and the potential for debris, pests, and moisture to infiltrate the space. Without proper sealing, the garage becomes less secure and less efficient, impacting both the functionality and the comfort of the area.

In other instances, garage doors might be installed without a door jamb. Without a door jamb the structural integrity of the garage door can be compromised, leading to potential misalignment and difficulty in opening or closing the door properly. This absence can also reduce the door's ability to effectively block out weather elements and provide security, as the lack of proper framing can create vulnerabilities and weak points in the overall structure.

Weather stripping and door sweeps aim to block openings around the door edges and at the bottom where pests can enter. These materials are typically made of rubber, vinyl, or metal and are designed to create a seal when the door is closed. However, over time, they can wear out, become misaligned, or be chewed through by determined pests. They require regular inspection and maintenance to remain effective and their durability against persistent pests is limited.

Wire mesh can be used to cover openings and vents, while caulk is applied to seal cracks and crevices. While these methods can be effective, they are not foolproof. Small pests can squeeze through or chew through the mesh, and caulk can deteriorate over time, leaving gaps for pests to exploit. Additionally, applying wire mesh and caulk can be labor-intensive and may not address all potential entry points.

Threshold seals are installed at the base of garage doors to block the gap between the door and the floor. Like weather stripping, they can become damaged or misaligned, allowing pests to enter. Additionally, threshold seals may not be effective against all types of pests, particularly those that can burrow or chew through materials. Their effectiveness is also compromised by the natural settling and shifting of the garage structure over time.

Automated garage door systems include sensors and motors that ensure the door closes securely. While these systems can help reduce gaps and improve sealing, they do not address all vulnerabilities. Pests can still find their way through small openings, and the systems themselves can be expensive to install and maintain.

Ultrasonic pest repellents emit high-frequency sound waves intended to deter pests from entering the garage. However, their effectiveness is widely debated. Some pests may become accustomed to the noise over time, rendering the devices ineffective. Moreover, these devices do not provide a physical barrier and should be used in conjunction with other methods for optimal results.

Smart home systems can include pest detection and deterrent features, such as motion-activated lights or cameras that alert homeowners to pest activity. While these systems can enhance monitoring and provide early warnings, they do not prevent pests from entering. They are also expensive, difficult and costly to install, and dependent on technology and internet connectivity, which can be unreliable.

Traps, such as snap traps, glue boards, and electronic traps, are traditional methods of pest control. While they can be effective in capturing individual pests, they do not address the root cause of the infestation. Traps require frequent monitoring and resetting, and they can be unsightly and hazardous if not properly managed. They also do not prevent new pests from entering the garage.

Pesticides are commonly used to control pest populations. However, they offer only temporary relief and often fail to eliminate the source of the problem. Pests can develop resistance to chemicals, making them less effective over time. Additionally, the use of pesticides poses health risks to humans and pets, and their application requires regular maintenance, which can be costly and time-consuming.

Pests can infiltrate garages and homes through remarkably small openings. Understanding how pests utilize these entry points is essential for effective prevention.

Pests, particularly rodents and insects, can squeeze through tiny cracks and gaps around doors, windows, foundations, pipes, wiring, and other openings. Generally, pests will look for any opening that is at least ⅛ inch wide. For instance, a mouse can fit through a gap as small as ¼ inch wide, while insects like ants can exploit even narrower spaces. This ability is due to their flexible bodies and, in the case of insects, segmented exoskeletons that allow for significant compression.

Rodents are especially adept at enlarging smaller holes or chewing their way through to make an opening big enough to get through. Small holes may be left in structures from removed nails, woodpecker damage, or decaying wood, providing an entry point. Gaps in physical structures may exist between doors, walls, cabinets, and pipes, allowing rodents to slide or crawl through if the gaps are wider than ⅛ inch.

Similar to holes and cracks, hidden voids like those found in attics, under floors, and behind walls provide undetected access for pests. They may chew wood or insulation to create routes between voids and the structure. Areas where the foundation of a building meets the wall slab or floor also provide opportunities for pests to enter. Pests can dig or chew their way in at the junction points of a foundation. Damaged or weathered wood can further provide access points as it breaks down more easily, allowing pests to bore into it. Decaying wood offers little resistance, facilitating entry. As buildings settle over time, structural cracks form in concrete walls, slabs, and foundations, which pests use to gain access to the inside of a building.

Holes left unsealed after installing plumbing pipes, electrical wiring, or cable provide easy access points for small pests to get through walls and into a structure. Properly sealing all these potential pest entry points is key to an effective pest-proofing strategy. Regular inspections help identify any new holes or damage so they can be sealed before pests have a chance to break through.

Environmental conditions can also impact pest entry. Extreme weather conditions, such as heat, cold, or moisture, can warp garage doors, creating gaps. Additionally, clutter in garages provides ample hiding spots and nesting materials for pests, making regular cleaning and organization essential components of pest prevention.

Garage walls are typically constructed from wood framing covered with exterior materials such as vinyl siding, stucco, or brick veneer. The interior walls may be finished with drywall or plywood. Between the studs, insulation such as fiberglass or foam board is installed to improve thermal efficiency. While the exterior materials provide a barrier against the elements, they can develop gaps and cracks where different materials meet or due to damage and wear over time. Pests can exploit these openings to gain entry.

Garages may have windows to allow natural light and ventilation. These windows are typically framed in wood or metal and fitted with glass panes. Weather stripping and caulking are used to seal the edges of the windows, but like door seals, these materials can deteriorate over time. Small gaps around window frames can allow insects and small rodents to enter the garage.

The garage door is one of the most critical components in pest prevention. It is often made of steel, aluminum, wood, or composite materials. Modern garage doors are designed with weather stripping and bottom seals to create a tight fit against the floor and sides of the door frame. However, these seals can degrade over time, becoming brittle and worn, which allows gaps to form. Additionally, the constant movement of the door can cause misalignment, further compromising the seal and providing entry points for pests.

The door jambs and thresholds provide structural support and help seal the perimeter of the garage door. Weather stripping and threshold seals are used to close gaps between the door and the frame. Despite their importance, these components are prone to wear and damage. Weather stripping can become misaligned or torn, and threshold seals can crack or deteriorate, allowing pests to enter.

While the structure of a garage incorporates various components designed to protect against external elements, including pests, these measures often fail due to wear, damage, and inherent vulnerabilities. Cracks in the foundation and walls, degraded seals around doors and windows, gaps around utility penetrations, and small openings in the roof and eaves all provide entry points for pests. Effective pest prevention requires regular inspections, maintenance, and the use of durable materials to address these vulnerabilities and keep pests out of the garage.

Metal plates are commonly used in construction to provide reinforcement and structural integrity to walls and ceilings. These plates, typically made of steel or aluminum, are embedded within layers of wood, concrete, or drywall. They help prevent structural components from bowing or collapsing under significant weight or force, distributing the load and ensuring the stability of the building. Despite these benefits, traditional metal plates are inadequate for preventing pest entry, particularly in garage areas, for several reasons.

Traditional metal plates are often produced in standard rectangular or square shapes and sizes. These uniform dimensions do not conform to the unique contours and gaps around garage doors and other potential entry points. This lack of customization leaves small openings that pests can exploit, rendering the plates ineffective in preventing entry.

Metal plates are not typically installed near garage doors or used as a sealing agent. They are generally placed within the walls and ceilings during the initial construction phase to reinforce load-bearing elements. As a result, they do not address the specific vulnerabilities around garage doors, where gaps and openings are most likely to occur. The absence of metal plates in these critical areas leaves garages susceptible to pest infiltration.

Metal plates are not typically installed near garage doors or used as a sealing agent. They are generally placed within the walls and ceilings during the initial construction phase to reinforce load-bearing elements. As a result, they do not address the specific vulnerabilities around garage doors, where gaps and openings are most likely to occur. The absence of metal plates in these critical areas leaves garages susceptible to pest infiltration.

The inherent rigidity of metal plates makes them unsuitable for areas that require a flexible solution, such as the edges and seals of garage doors. Garage doors need to move smoothly to function properly, and rigid metal plates can interfere with this movement, leading to misalignment and creating additional gaps. These gaps can then be exploited by pests, further compromising the effectiveness of the barrier.

While metal plates are effective when installed during the initial construction phase, retrofitting them into existing structures, especially around garage doors, is challenging and often impractical. Existing garages typically lack this level of reinforcement, and adding metal plates post-construction does not adequately address the unique contours and sealing requirements of garage doors.

The present pest deterrent invention provides an innovative solution specifically designed to prevent pest entry through gaps between garage doors and door jambs. This invention focuses on creating a robust and adaptable barrier that conforms to the unique contours of garage doors and seals potential entry points, offering a more reliable and durable defense against pest infestations.

The pest deterrent solution includes custom-fit metal barriers that are designed to fit precisely around the contours of garage doors and jambs. Unlike traditional metal plates, these barriers are specifically shaped to match the unique dimensions and sealing requirements of garage doors, ensuring no gaps are left for pests to exploit. The use of high-quality, pest-resistant materials that are resistant to chewing and gnawing ensures long-term effectiveness and reduces the need for frequent maintenance.

Proper installation of the present invention requires an understanding of the various components of a garage, particularly the door seal and door jamb. A door jamb is the vertical piece that forms the sides of a door frame. Door jambs run vertically along the sides of the door opening and provide structure and support for the door frame. A door seal, on the other hand, is a weatherstripping or gasket that seals the gap between a door and the door jamb. Door seals help prevent air leaks, drafts, water, and pests from getting through the door opening.

Door jambs are structural parts of the door frame, while door seals are flexible seals or pads. Door jambs are fixed in place and provide the necessary shape and support for the doorway, whereas door seals can be attached or detached from the door jambs and create a tight seal around the doorway. Door jambs are typically made of materials such as wood, metal, or vinyl, which provide durability and structural integrity. In contrast, door seals are made of flexible and compressible materials like rubber, foam, or vinyl, which help in creating an airtight and weatherproof seal.

Identifying the door jamb and door seal of a garage door is the first step to installing a pest deterrent system. An installer must look for gaps or cracks around the edges of the garage door. These gaps can indicate where door jambs and seals need reinforcement. Door jambs fill gaps and provide a weather-tight seal, but if damaged or poorly installed, they can compromise the door's structural integrity and allow pests to enter.

Inspecting the sides of the garage door tracks is also essential, as the tracks guide the door open and closed. Bent, rusted, or damaged tracks can prevent the door from closing properly, creating gaps. Checking the top of the garage door is also crucial; a rubber or vinyl seal is often placed along the top edge to block air leaks and provide weatherstripping. Any tears, cracks, or gaps in this seal can compromise its effectiveness.

For metal garage doors, it's important to inspect metal-to-metal contact points and ensure the seals or gaskets at these contact points are intact and sealing properly. Metal garage doors may have more substantial weatherstripping compared to regular doors, including rubber seals, foam seals, or vinyl seals, to prevent air leaks and weather intrusion.

Garage door seals typically have more substantial weatherstripping, like rubber seals, foam seals, or vinyl seals, to prevent air leaks and weather intrusion. Garage door jambs and seals usually have room for caulk or sealant to fill any air gaps and seal the joint, while regular door jambs simply meet the sides of doorways more tightly. Garage door jambs often have adjustments or spacers so the seal can properly engage the door at various open positions, whereas regular door jambs typically nail into place.

Jambs for garage doors are often made of durable, weather-resistant materials like steel, aluminum, or vinyl, designed to withstand harsher conditions. Regular door jambs may be made of wood, vinyl, metal, or wood composites. Due to weathering and wear, garage door seals and jambs tend to require more frequent replacement compared to regular door seals and jambs, which can last much longer.

Proper installation of the pest deterrent involves several detailed steps to ensure they fit correctly and function effectively. Below is a comprehensive procedure for installing pest deterrents on a garage door. To begin, the necessary tools and safety gear are recommended, including a pry bar, wood chisel, hammer, diagonal cutting pliers, safety goggles, work gloves, and sturdy shoes.

The vinyl door seal must be pried away from the door jamb to create a gap extending from the concrete base up to approximately 8 inches. This gap allows for the insertion of the pest deterrent. The nails securing the seal are cut with diagonal cutting pliers to ensure they are flush with the seal, providing a smooth surface for the installation.

The pest deterrent, made of aluminum, is selected for its specific dimensions and angles. The design includes a diagonal angle, or trapezoidal taper, that should be positioned upwards, conforming to the shape of the door seal. The smaller side curve, or the anterior side, of the pest deterrent faces towards the interior of the garage. This configuration ensures that the pest deterrent fits snugly against the door seal without any exposed aluminum beyond the seal, maintaining an aesthetic appearance while effectively blocking pest entry.

The pest deterrent is then secured by nailing through the seal and aluminum into the door jamb. The angle of the pest deterrent must align with the flexible part of the door seal to ensure a tight fit. The installation is confirmed by operating the garage door, ensuring that the pest deterrent does not interfere with the door's movement. The ideal installation results in a slight gap, approximately ⅛ inch, between the pest deterrent and the garage door when closed, preventing pests from entering without scratching the door.

In one embodiment, the pest deterrent is installed directly against the garage frame and underneath the door jamb where the garage door does not have a door seal or door jamb. This ensures that the deterrent is securely placed to block entry points effectively without relying on additional sealing components.

In another embodiment, the pest deterrent is installed directly against the door jamb but not underneath the seal when the garage is missing a door seal. This configuration leverages the existing structure of the door jamb to provide an effective barrier against pests.

In other embodiments, where the garage does not have a door jamb or door seal, the pest deterrent is installed directly onto the garage framing, leaving the deterrent exposed. While this may not be aesthetically pleasing, it remains functionally effective in preventing pest entry.

Creating the pest deterrent involves an aluminum stamping process, resulting in a product with distinct left and right sides forming the complete deterrent. The pest deterrent consists of a rectangular piece connected to another side via an angled section, including a portion with an edge designed for optimal fit and function.

The manufacturing process begins with preparing aluminum sheets or coils, which are selected based on specific thickness and quality requirements to ensure durability and effectiveness. Custom-made stamping dies are created, featuring a male component with a raised design and a female component with a corresponding recessed shape. The design of these dies is crucial, as it determines the final shape and features of the pest deterrent.

In the stamping process, the aluminum material is placed between the stamping dies within a press, which can be hydraulic or mechanical. When the press activates, significant force is applied, causing the aluminum to conform to the shape of the dies, producing the required sections of the pest deterrent. This process can be performed in a single-stage manner, where one operation is completed at a time, or in a progressive manner, where multiple operations occur simultaneously on a continuous strip of material. The choice between these methods depends on the production requirements and efficiency goals.

Lubricants are often used during the stamping process to reduce friction and minimize wear on both the dies and the aluminum material. This helps maintain the quality and precision of the stamped parts while extending the lifespan of the tooling. After stamping, the aluminum sections are precisely formed into the pest deterrent's final configuration, ensuring the correct angles and edges for proper installation and functionality.

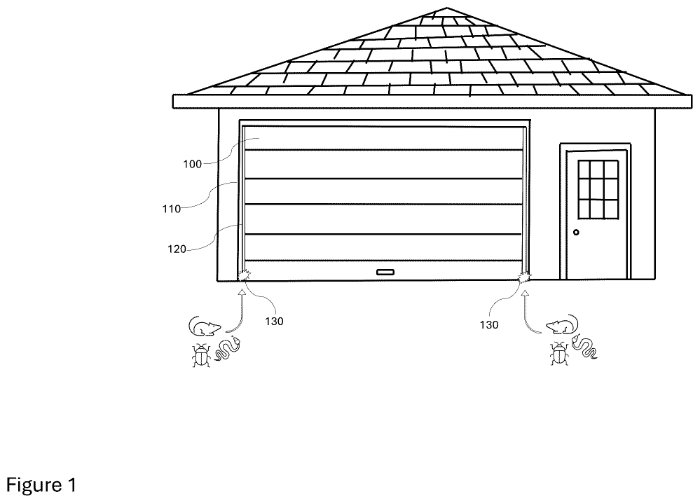

Referring now to the drawings, as shown in FIG. 1, is a perspective view of a garage including unwanted points of entry for pests through gaps 130 between a garage door 100 and garage door jambs 110 and seals 120. A standard garage typically includes a large, retractable door 100 that serves as the primary entry and exit point for vehicles and large items. Garage door 100 is usually constructed from materials such as steel, aluminum, wood, or composite materials. It is designed to move vertically, rolling up into the ceiling space of the garage when opened, and lowering back into place to close the entryway. Garage door 100 may consist of multiple panels connected by hinges, allowing it to bend as it moves along tracks on either side. The garage door 100 is an essential component of the overall structure and is framed by door jambs 110. The door jambs 110 are fixed vertical supports that frame the sides of the garage door opening. The door jambs 110 are typically made from wood or metal and provide the necessary stability and alignment for the garage door's operation. Door jambs 110 also serve as the mounting points for the track and hardware that guides the garage door's movement. Attached to the door jambs 110 are door seals 120, also known as weatherstripping or vinyl seals. The door seals 120 are installed along the vertical edges of the garage door 100, where it meets the door jambs 110. Garage door seals 120 often have a flat or angled design, allowing them to create a continuous barrier along the sides of the door. Seals 120 are attached to the door jambs 110 using nails, screws, or adhesive strips. They are positioned so that they press against the sides of the garage door 100 when it is closed, creating a seal. The door seals 120 are designed to provide protection against drafts, moisture, and pests. However, over time, these seals can become worn, damaged, or improperly aligned, creating entry points 130 for pests.

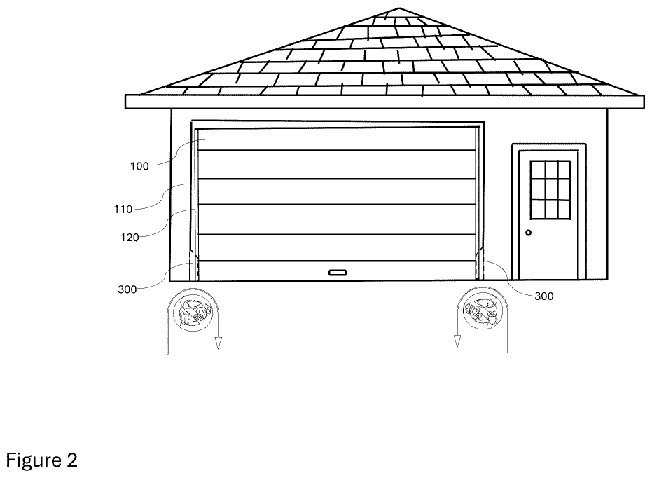

FIG. 2, is a perspective view of the garage with pest deterrent devices 300 installed under door jambs 110 and door seals 120 which frame garage door 100. Pest deterrent devices 300 are installed with the shorter anterior side 340 of the pest deterrent device facing garage door 100, facilitated by angle of bend 320. The longer posterior side 330 of the pest deterrent is fastened adjacent to the garage door 100 and underneath and perpendicular to the door jamb 110 and door seal 120. The pest deterrent devices' trapezoidal taper 310 are facing upward, with the opposite flat end resting flush with the floor. Notably, pest deterrent devices 300 are preventing pests from entering the garage through gaps 130, which are represented in FIG. 1.

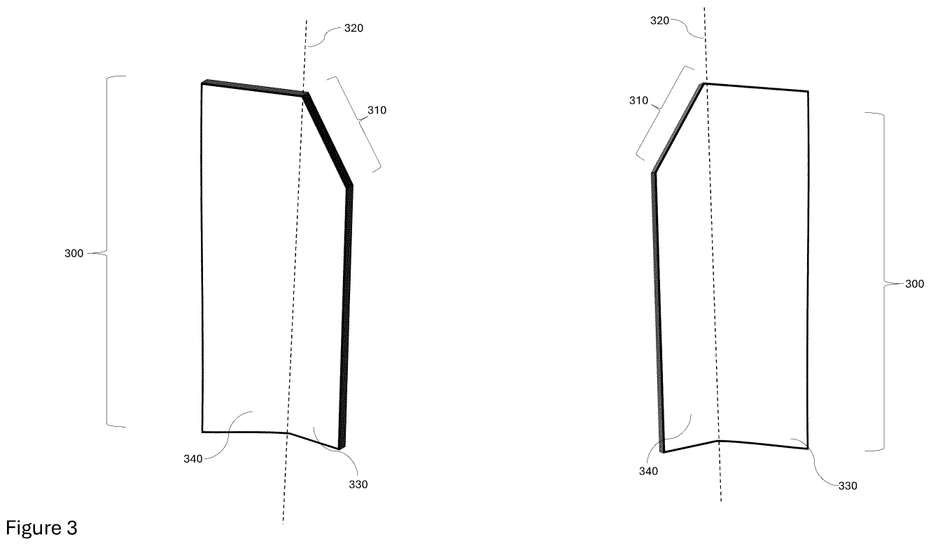

FIG. 3, illustrates a three-dimensional schematic view of both the right and left configurations of the pest deterrent devices 300. The devices 300 feature a distinguishably longer posterior side 330 and a shorter anterior side 340. The shorter anterior side 340 is characterized by a trapezoidal taper 310. When installed, this shorter anterior side 340 is oriented towards the garage door. The axis of bend 320 is positioned approximately 1.5 to 1.85 inches from the shorter anterior side 340, providing a clear reference for proper alignment and installation of the device.

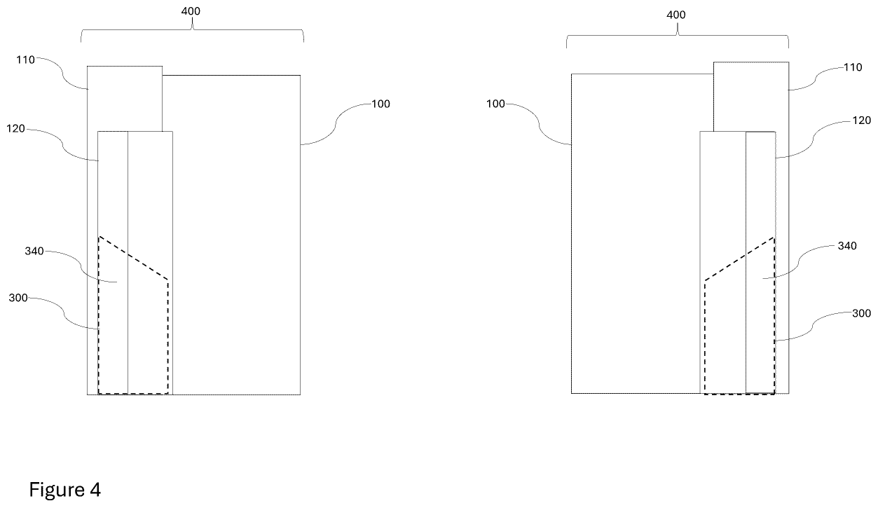

FIG. 4, illustrates magnified, cross-sectional views of both the right and left pest deterrent devices 300 installed behind the door seal 120 and in front of the door jamb 110. FIG. 4, provides a detailed depiction of the device's position and interaction with the door seal when viewed from the exterior and toward the garage door 100. Pest deterrent devices 300 are installed with the shorter anterior side 340 of the pest deterrent device facing garage door 100, facilitated by angle of bend 320. The longer posterior side 330 of the pest deterrent is fastened adjacent to the garage door 100 and underneath and perpendicular to the door jamb 110 and door seal 120. The pest deterrent devices' trapezoidal taper 310 are facing upward, with the opposite flat end resting flush with the floor.

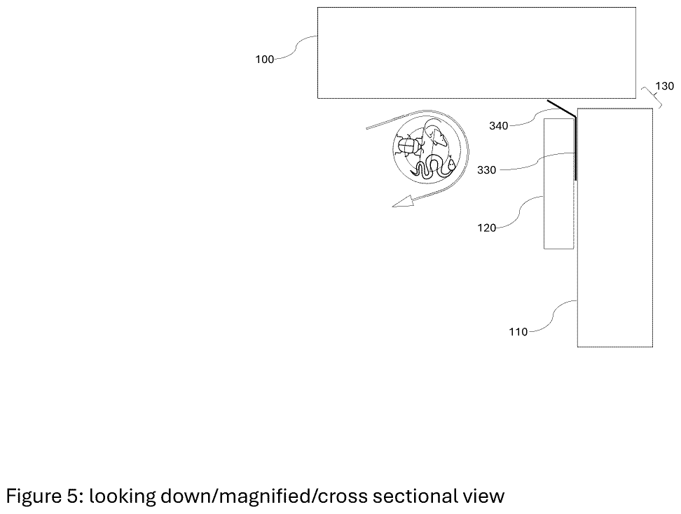

FIG. 5, contains the same components as FIGS. 2, 3, and 4 and provides a magnified cross-sectional view looking down at the pest deterrent device 300 installed behind the garage door seal 120. This illustration shows the right side only; however, the left side can be visualized similarly by flipping the image horizontally. In this configuration, the pest deterrent device 300 is installed with the shorter anterior side 340 facing the garage door 100. The device 300 is positioned above and perpendicular to the door jab 110 and underneath the door seal 120. The trapezoidal taper 310 of the pest deterrent device faces upward, while the opposite flat end rests flush with the floor. This setup effectively prevents pests from entering the garage through gaps 130 between the garage door 100 and the door jamb 110.

It is claimed:

1. A method of generating a pest deterrent for installation between a garage door and a door jamb, comprising:
Providing two rectangular sheet metals;
Cutting each rectangular sheet metal diagonally to form a trapezoidal taper on one side, wherein the side with the trapezoidal taper is shorter in height than an opposite, posterior side;
Bending the trapezoidal taper side inward along a vertical axis as approximately 0.60 to 0.75 degrees, creating an anterior side;
Ensuring that the anterior side of each pest deterrent is oriented to face toward the garage door when installed, and the posterior side is oriented to face toward the door jamb when installed;
Providing one pest deterrent for the left side of a garage door and one for a right side of the garage door.

2. The method of claim 1, wherein the rectangular sheet metals have a thickness ranging from 0.02 to 0.04 inches.

3. The method of claim 1, wherein the rectangular sheet metals have a height of approximately 5.5 to 6.5 inches on the posterior side and approximately 4.5 to 5 inches on the anterior side.

4. The method of claim 1, wherein the rectangular sheet metals have a width ranging from 1.7 to 1.9 inches.

5. The method of claim 1, wherein two lateral sides connect the anterior and posterior sides, with one lateral side ranging from 4.5 to 5 inches, with one lateral side ranging from, 5.5 to 6.5 inches in height.

6. The method of claim 1, wherein the bending occurs along the vertical axis at approximately 1.2 inches from the edge of the anterior side.

7. The method of claim 1, wherein the shorter anterior side of each trapezoidal sheet metal is bent inward at an angle of approximately 0.65 to 0.75 degrees.

8. A method of preventing pest intrusion into a garage, comprising
installing a pest deterrent to cover a gap extending from a garage door jamb;
identifying the door seal or door jamb adjacent to a garage door;
prying away the door seal or door jamb to create a gap of approximately 0.5 to 8.5 inches from the door seal or door jamb and the concrete;
cutting a fastener with diagonal cutting pliers from behind the door seal and flush with the door seal;
fastening a pest deterrent with a diagonal angle oriented upward, aligning the pest deterrent to conform closely to the contour of the door seal;
positioning the anterior side of the pest deterrent to face inward toward the garage;
providing a fastener, such as a nail, that passes through the door seal and the posterior side of the pest deterrent to the door jamb;
ensuring the pest deterrent's angle of bend is equivalent to a flexible part of the door seal;
operating the garage door to verify that the pest deterrent does not rub against the garage door;
confirming the pest deterrent slightly touches the garage door when in a closed configuration.

9. An apparatus for deterring pests from entering a space comprising:
at least two rectangular sheet metals, each sheet metal cut diagonally to form a trapezoidal taper on one side, wherein the side with the trapezoidal taper is shorter in height than an opposite, posterior side;
the sheet metal further configured with a bend on the trapezoidal taper side inward along a vertical axis as approximately 0.60 to 0.75 degrees, creating an anterior side;
The anterior side further configured to be oriented to face toward the garage door when installed, and the posterior side oriented to face toward the door jamb when installed.

10. The apparatus of claim 9 wherein the rectangular sheet metals have a thickness ranging from 0.02 to 0.04 inches.

11. The apparatus of claim 9, wherein the rectangular sheet metals have a height of approximately 5.5 to 6.5 inches on the posterior side and approximately 4.5 to 5 inches on the anterior side.

12. The apparatus of claim 9, wherein the rectangular sheet metals have a width ranging from 1.7 to 1.9 inches.

13. The apparatus of claim 9, wherein two lateral sides connect the anterior and posterior sides, with one lateral side ranging from 4.5 to 5 inches, with one lateral side ranging from, 5.5 to 6.5 inches in height.

14. The apparatus of claim 9, wherein the bending occurs along the vertical axis at approximately 1.2 inches from the edge of the anterior side.

15. The apparatus of claim 9, wherein the shorter anterior side of each trapezoidal sheet metal is bent inward at an angle of approximately 0.65 to 0.75 degrees.
